(19) United States
(12) Patent Application Publication
(10) Pub. No.: US 2016/0088535 A1
(43) Pub. Date: Mar. 24, 2016

(54) COMMUNICATION METHOD AND COMMUNICATION APPARATUS

(71) Applicant: MITSUBISHI ELECTRIC CORPORATION, Chiyoda-ku (JP)

(72) Inventor: Taisei SUEMITSU, Tokyo (JP)

(73) Assignee: MITSUBISHI ELECTRIC CORPORATION, Chiyoda-ku (JP)

(21) Appl. No.: 14/889,104

(22) PCT Filed: May 14, 2014
(86) PCT No.: PCT/JP2014/062834

§ 371 Date: Nov. 4, 2015

(30) Foreign Application Priority Data
Jun. 21, 2013 (JP) 2013-130081

(51) Int. Cl. H04W 36/00; H04W 36/04; H04W 16/32

(52) U.S. Cl. CPC H04W 36/0083; H04W 16/32; H04W 36/04

(57) ABSTRACT

A communication apparatus is a base station involved in communication between a network and a terminal. The terminal is communicable with the network also via another base station. The communication apparatus includes: a routing unit that requests, from the network, establishment of a communication path from the network to the communication apparatus; and a download completion monitoring unit that monitors whether or not the terminal has completed a download of data from the network via the base station and, when deciding that the download has been completed before a lapse of a predetermined period of time from the establishment, requests a handover to the other base station without requesting the other base station to release user information of the terminal.

### TECHNICAL FIELD

The present invention relates to a communication technology, and for example, is applied to communication between a plurality of base station apparatuses and a mobile station apparatus, such as LTE (Long Term Evolution) and LTE advanced.

### BACKGROUND ART

Non-Patent Documents 1 and 2 define handovers between two different base stations (URL: http://www.3gpp.org/ftp/Specs/archive/36_series/36.300/36300-b50.zip, http://www.3gpp.org/ftp/Specs/archive/36_series/36.331/36331-a30.zip, accessed Apr. 24, 2013).

It is presented in Patent Documents 1 and 2 that in a system environment in which the area of a microcell is located within the area of a macro cell, the macro cell accommodates channels for lower rate transmission, and the micro cell accommodates channels for higher rate transmission.

Patent Documents 3 to 14 present communication between a mobile station and a base station.

### PRIOR ART DOCUMENTS

### Patent Documents

Patent Document 1: Japanese Patent Application Laid-Open No. 2001-339770

Patent Document 2: Japanese Patent Application Laid-Open No. 2001-346265

Patent Document 3: Japanese Patent Application Laid-Open No. 2011-61464

Patent Document 4: Japanese Patent No. 4838483

Patent Document 5: Japanese Patent No. 4303587

Patent Document 6: Japanese Translation of PCT International Application Publication No. 2004-536533

Patent Document 7: WO 07/015552

Patent Document 8: Japanese Patent Application Laid-Open No. 2009-162771

Patent Document 9: Japanese Patent No. 5051857

Patent Document 10: Japanese Translation of PCT International Application Publication No. 2010-531626

Patent Document 11: Japanese Translation of PCT International Application Publication No. 2011-526442

Patent Document 12: Japanese Translation of PCT International Application Publication No. 2012-517190

Patent Document 13: Japanese Translation of PCT International Application Publication No. 2012-517191

Patent Document 14: WO 12/093582

### Non-Patent Documents

Non-Patent Document 1: 3rd Generation Partnership Project (3GPP) “TS36.300”, V11.5.0, 2013.3

Non-Patent Document 2: 3rd Generation Partnership Project (3GPP) “TS36.331”, V11.3.0, 2013.3

### SUMMARY OF INVENTION

### Problem to be Solved by the Invention

According to Patent Documents 1 and 2, while the base stations require no high output transmission amplifiers and the apparatus cost of base stations is accordingly reduced, switching between the base stations through a handover is not speeded up.

In the technologies of Patent Documents 3 to 14, a macro cell and a small cell do not coexist while occupying different transmission rates. Besides, none of these documents teaches speeding up of a handover.

Under the circumstances, the present invention has an object to switch, at high speed, a base station being a communication apparatus that is transited when a terminal communicates with a network.

### Means to Solve the Problem

A first aspect of a communication method according to the present invention is a communication method in a communication system including a network, a first base station, a second base station, and a terminal connectable to the network via any of the first base station and the second base station.

The communication method includes the steps of: (a) issuing, by the terminal being connected to the network via the first base station and not being connected to the second base station, a reception request for requesting a download of data to the first base station; (b) determining, by the first base station, whether or not to connect the terminal to the second base station correspondingly to the reception request; (c) causing, by the first base station, the second base station to admit that the terminal is to be connected to the second base station when the determination of the step (b) is affirmative; (d) after the step (c), transmitting, by the terminal, a notification indicating that communication between the terminal and the second base station is enabled to the second base station; and (e) after the step (d), after the terminal has completed the download, enabling, by the first base station, communication from the network via the first base station without determining whether or not to connect the terminal to the first base station.

A second aspect of the communication method according to the present invention further includes the following step (t) in the first aspect.

Specifically, the step of (f), after the step (d), upon completion of the download within a predetermined period, enabling the communication from the network via the first base station without releasing information on the terminal from the first base station, is further included.

A third aspect of the communication method according to the present invention further includes, in the first or second aspect, the step of (g) after the step (d), releasing the information on the terminal from the first base station when the download has not been completed within a predetermined period.

In a fourth aspect of the communication method according to the present invention, in any one of the first to third aspects, a communication area of the first base station is larger than a communication area of the second base station.

In a fifth aspect of the communication method according to the present invention, in any one of the first to fourth aspects, a transmission rate of the second base station is higher than a transmission rate of the first base station.

In a sixth aspect of the communication method according to the present invention, in the fifth aspect, communication of the terminal with both of the first base station and the second base station is radio communication, and a value of a frequency used in the radio communication performed between the terminal and the first base station differs from a value of a frequency used in the radio communication performed between the terminal and the second base station.

In a seventh aspect of the communication method according to the present invention, in any one of the first to sixth aspects, in the step (b), a capacity of the data requested in the step (a) is notified from the network to the first base station, and connecting the terminal to the second base station is decided when the capacity of the data is greater than a predetermined value.

A first aspect of a communication apparatus according to the present invention is a communication apparatus being a base station involved in communication between a network and a terminal. The terminal is communicable with the network also via another base station. The communication apparatus includes: a routing unit that requests, from the network, establishment of a communication path from the network to the communication apparatus; and a download completion monitoring unit that monitors whether or not the terminal has completed a download of data from the network via the base station and, when deciding that the download has been completed before a lapse of a predetermined period of time from the establishment, requests a handover to the other base station without requesting the other base station to release user information of the terminal.

A second aspect of a communication apparatus according to the present invention is a communication apparatus being a base station involved in communication between a network and a terminal. The terminal is communicable with the network also via another base station. The communication apparatus includes: a routing unit that requests, from the network, establishment from the network to the communication apparatus; and a download completion monitoring unit that monitors whether or not the terminal has completed a download of data from the network via the base station and, triggered by a decision that the download has been completed, requests a handover to the other base station.

A third aspect of a communication apparatus according to the present invention is a communication apparatus being a base station involved in communication between a network and a terminal. The terminal is communicable with the network also via another base station. The communication apparatus includes: a routing unit that requests, from the network, a process of causing a communication path from the network to the terminal to transit the other base station; a download completion monitoring unit that monitors whether or not the terminal has completed a download of data from the network via the base station; and a user information managing unit that requests, when deciding that a predetermined period of time has elapsed since the process before the download is completed, the other base station to release user information of the terminal.

A fourth aspect of a communication apparatus according to the present invention is a communication apparatus being a base station involved in communication between a network and a terminal, and the communication apparatus includes a data capacity acquiring unit that obtains, triggered by receipt of a reception request from the terminal for requesting reception of data from the network, information on a capacity of the data from the network; and a handover deciding unit that decides whether or not to cause the terminal to be connected to another base station on the basis of the capacity of the data.

### Effects of the Invention

According to the first aspect of the communication method of the present invention, the process for enabling communication from the network via the first base station is started quickly.

According to the second aspect of the communication method of the present invention, the process for enabling communication from the network via the first base station is performed quickly.

According to the third, fourth, and seventh aspects of the communication method of the present invention, a reduction in the traffic capacity of the first base station is prevented.

According to the fifth aspect of the communication method of the present invention, the process of the second base station can be dedicated to the process for the communication requiring a high transmission rate, while the first base station can be dedicated to the process for the communication requiring a low transmission rate.

According to the sixth aspect of the communication method of the present invention, the radio communication performed at high transmission rate with high power is less likely to interfere with the radio communication performed at low transmission rate with low power.

The first aspect of the communication apparatus according to the present invention contributes to the realization of the first and second aspects of the communication method according to the present invention.

The second aspect of the communication apparatus according to the present invention contributes to the realization of the first aspect of the communication method according to the present invention.

The third aspect of the communication apparatus according to the present invention contributes to the realization of the third aspect of the communication method according to the present invention.

The fourth aspect of the communication apparatus according to the present invention contributes to the realization of the seventh aspect of the communication method according to the present invention.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a view explaining a communication system according to a first embodiment.

FIG. 2 is a view explaining a communication system according to a second embodiment.

FIG. 3 is a block diagram showing the configuration of a first base station according to a fifth embodiment.

FIG. 4 is a block diagram showing the configuration of a second base station according to the fifth embodiment.

### DESCRIPTION OF EMBODIMENTS

### First Embodiment

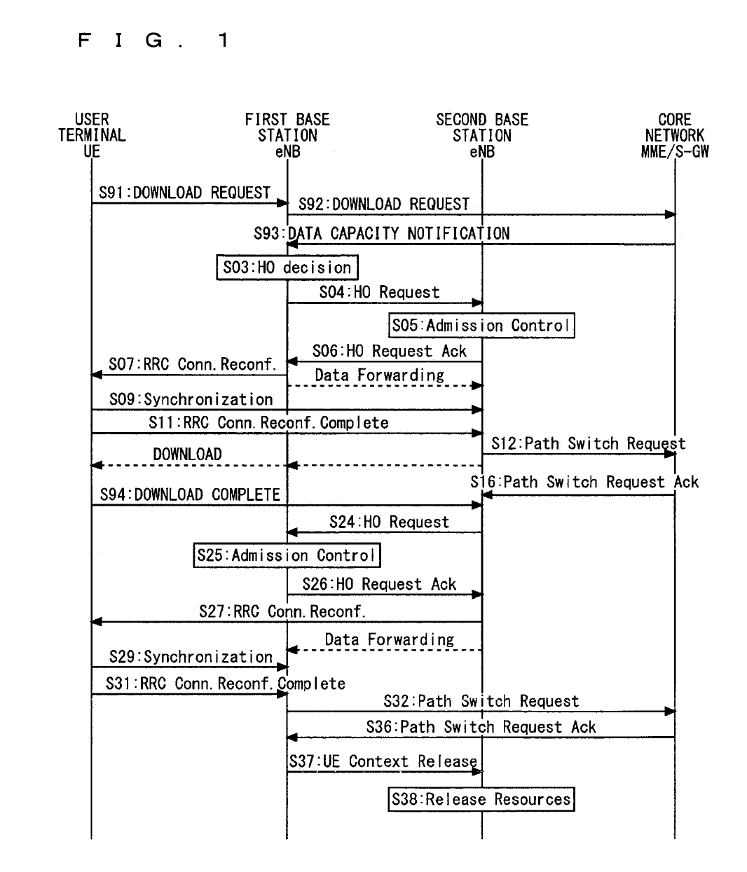

FIG. 1 is a view explaining a communication system according to a first embodiment. A user terminal UE (for example, User Equipment referred to in 3GPP TS36.300) and a first base station eNB and a second base station eNB (for example, both of which are E-UTRAN Nodes B referred to in 3GPP TS36.300) are all communication apparatuses. The user terminal UE is connectable to a network via any of the first base station eNB and the second base station eNB. Illustrated here as the network is a core network MME/S-GW. The core network MME/S-GW has a configuration in which, for example, the MME (Mobility Management Entity) and S-GW (Serving Gateway) referred to in 3GPP TS36.300 are recognized as a whole.

The following describes, for brevity, an example of the case in which both of the first base station eNB and the second base station eNB are connected to the same core network MME/S-GW (Intra-MME). Even if the core network MME/S-GW connected with the first base station eNB differs from the core network MME/S-GW connected with the second base station eNB, however, these core networks MME/S-GW may be recognized as a network as a whole. Alternatively, in the application across different RATs (Radio Access Technologies), similar effects can be achieved in a similar manner.

In the execution of Step S91, the user terminal UE is connected to the core network MME/S-GW via the first base station eNB and is not connected to the second base station eNB.

In Step S91, the user terminal UE notifies the first base station eNB of a data reception request (download request). Triggered by receipt of the download request, in Step S92, the first base station eNB notifies the core network MME/S-GW of a download request.

In response to the download request, the core network MME/S-GW obtains information on the capacity (data capacity) of the data being a target for the download from the Internet network (not shown). Then, in Step S93, the core network MME/S-GW notifies the first base station eNB of this.

In Step S03, the first base station eNB decides whether to perform a handover to the second base station eNB (for example, HO decision referred to in 3GPP TS36.300).

Specifically, for the data capacity higher than a predetermined value, an affirmative determination (a handover is performed) is made on the decision. Then, in Step S04, the first base station eNB notifies the second base station eNB of a handover request (for example, HO Request referred to in 3GPP TS36.300).

The illustration of the process when a negative determination (a handover is not performed) is made on the decision is omitted. For example, in this process, the user terminal UE downloads the data from the core network MME/S-GW via the first base station eNB.

In this embodiment, Step S03 does not necessarily need to be performed on the basis of the data capacity in Steps S91, S92, and S93. A process described below is also applicable to a case where, while the user terminal UE is connected to the core network MME/S-GW via the first base station eNB, the user terminal UE is temporarily connected to the core network MME/S-GW via the second base station eNB due to another event, and then, the user terminal UE is again connected to the core network MME/S-GW via the first base station eNB.

In Step S05, on the basis of Step S04, the second base station eNB configures parameters such as user information (for example, UE Context referred to in 3GPP TS36.300), so that admission control (for example, Admission Control referred to in 3GPP TS36.300) to admit the connection of the user terminal UE to the second base station eNB is performed.

Steps S04, S05, and S06 can accordingly be recognized as the steps in which, when a handover is decided to be performed in Step S03, the first base station eNB causes the second base station eNB to admit that the user terminal UE is to be connected to the second base station eNB.

After Step S05, in Step S06, the second base station eNB notifies the first base station eNB of an affirmative response (for example, HO Request Ack referred to in 3GPP TS36.300) to the handover request.

In Step S07, on the basis of Step S06, the first base station eNB notifies the user terminal UE of a message (for example, RRC Connection Reconfiguration referred to in 3GPP TS36.300) to perform a reconfiguration for communication with the second base station eNB.

To reduce a delay in the handover, while the user terminal UE is in data communication with the first base station eNB, the first base station eNB also forwards the data to the second base station eNB (for example, Data Forwarding referred to in 3GPP TS36.300).

After Step S07, in Step S09, the user terminal UE establishes synchronization (for example, Synchronization referred to in 3GPP TS36.300) conduction with the second base station eNB. This is performed, for example, via the RACH (Random Access Channel) conduction referred to in 3GPP S36.300.

In Step S11, further, the user terminal UE notifies the second base station eNB of a message (for example, RRC Connection Reconfiguration Complete referred to in 3GPP TS36.300) indicating that the reconfiguration of the communication (which enables communication between the user terminal UE and the second base station eNB) has been completed.

After that, communication between the user terminal UE and the second base station eNB is enabled, so that the user terminal UE can download the data whose download has been requested (dashed arrows in the figure).

In Step S12, on the basis of the notification of Step S11, the second base station eNB notifies the core network MME/S-GW that the handover has been performed (for example, Path Switch Request referred to in 3GPP TS36.300).

Although FIG. 1 shows that the download is after Step S12, the download may be before Step S12.

In Step S16, in response to Step S12, the core network MME/S-GW notifies the second base station eNB of an affirmative response (for example, Path Switch Request Ack referred to in 3GPP TS36.300) to the request of Step S12.

According to the conventional technology, for example, 3GPP TS36.300, the first base station eNB is caused to release UE Context above after Path Switch Request Ack corresponding to Step S16. 3GPP TS36.300 and TS36.331, however, do not take into account a download before the completion (Handover Completion) of a handover sequence (handover procedure).

The user terminal UE, which has been connected to the core network MME/S-GW via the first base station eNB before the download request of Step S91, is connected to the core network MME/S-GW via the second base station eNB for a download, so to speak, temporarily in Steps S09, S11, and S12. After the download, accordingly, the user terminal UE is connected, as it was, to the core network MME/S-GW via the first base station eNB. The above-mentioned switching of base station eNBs transited when the user terminal UE is connected to the core network MME/S-GW is desirably performed at high speed.

In this embodiment, therefore, even when receiving a notification of Step S11, the second base station eNB does not allow the first base station eNB to release the user information until a predetermined period elapses thereafter. This enables the first base station eNB to quickly perform admission control (for example, Admission Control referred to in 3GPP TS36.300) for causing connection via itself between the user terminal UE and the core network MME/S-GW. This contributes to quick switching of base station eNBs transited when the user terminal UE is connected to the core network MME/S-GW.

FIG. 1 shows the case in which the user terminal UE notifies in Step S94 that a download of the data corresponding to Step S91 has been completed until a predetermined period elapses after the reception of the message of Step S11 by the second base station eNB.

As described above, the user terminal UE is connected, as it was, to the core network MME/S-GW via the first base station eNB. The second base station eNB accordingly notifies the first base station eNB of a handover request (for example, HO Request referred to in 3GPP TS36.300) triggered by receipt of the notification of Step S94 (Step S24) without deciding whether to perform a handover as executed by the first base station eNB in Step S03.

The process proceeds while the decision about whether to perform a handover is not performed as described above, thereby expediting the start of the process of quickly switching base station eNBs transited when the user terminal UE is connected to the core network MME/S-GW.

In Step S25, on the basis of Step S24, the first base station eNB configures parameters such as user information (for example, UE Context referred to in 3GPP TS36.300), so that admission control (for example, Admission Control referred to in 3GPP TS36.300) to admit that the user terminal UE is to be connected to the first base station eNB is performed.

After that, in Step S26, the first base station eNB notifies the second base station eNB of an affirmative response (for example, HO Request Ack referred to in 3GPP TS36.300) to the handover request, as in Step S06.

In Step S27, on the basis of Step S26, the second base station eNB notifies the user terminal UE of a message (for example, RRC Connection Reconfiguration referred to in 3GPP TS36.300) to perform a reconfiguration for communication with the first base station eNB, as in Step S07.

To reduce a delay in the handover, while the user terminal UE is in data communication with the second base station eNB, the second base station eNB forwards the data to the first base station eNB (for example, Data. Forwarding referred to in 3GPP TS36.300). In the forwarding after Step S27, however, the user terminal UE has completed a download via the second base station eNB. The forwarding is accordingly limited, unlike the forwarding performed after Step S07.

After Step S27, in Step S29, the user terminal UE establishes synchronization (for example, Synchronization referred to in 3GPP TS36.300) with the first base station eNB, as in Step S09. This is performed, for example, via the RACH (Random Access Channel) conduction referred to in 3GPP TS36.300.

In Step S31, further, the user terminal UE notifies the first base station eNB of a message (for example, RRC Connection Reconfiguration Complete referred to in 3GPP TS36.300) indicating that the reconfiguration of communication has been completed, as in Step S11.

In Step S32, on the basis of the notification of Step S31, the first base station eNB issues a request (for example, Path Switch Request referred to in 3GPP TS36.300) regarding a routing configuration to the core network MME/S-GW, as in Step S12.

On the basis of Step S32, the core network MME/S-GW performs the process of changing its communication path, from the second base station eNB to the first base station eNB (for example, Switch DL path referred to in 3GPP TS36.300, which is omitted in FIG. 1).

In Step S36, further, the core network MME/S-GW further notifies the first base station eNB of an affirmative response (for example, Path Switch Request Ack referred to in 3GPP TS36.300) to the request of Step S32, as in Step S16.

Consequently, the communication from the core network MME/S-GW via the first base station eNB is enabled.

Then, until a new event occurs, the connection from the user terminal UE to the core network MME/S-GW does not transit the second base station eNB. In Step S37, thus, the first base station eNB notifies the second base station eNB that the second base station eNB is requested to release the user information (for example, UE Context Release referred to in 3GPP TS36.300). This causes the second base station eNB to release the user information (for example, Release Resources referred to in 3GPP TS36.300) in Step S38.

When Step S94 is executed within a predetermined period after the execution of Step S11, in addition to the decision as to whether a handover is required in the second base station eNB, Steps S24 and S27 can be omitted. This is because the user information has not been released from the first base station eNB yet.

The omission of Step S24 leads to the omission of Steps S25 and S26. The omission of Step S27 leads to the omission of Step S31. Specifically, the first base station eNB can execute Step S29 while not receiving the message of Step S27 from the second base station eNB after Step S94, as long as it is not instructed to release the user information by the second base station eNB. Such omission of steps expedites the execution of Step S32, contributing to quick switching of base station eNBs transited when the user terminal UE is connected to the core network MME/S-GW.

### Second Embodiment

A second embodiment adopts the operations from Steps S91 to S16 described in the first embodiment. The second embodiment thus omits the description of those steps. The embodiment describes the process when Step S94 is not executed within a predetermined period after the execution of Step S11.

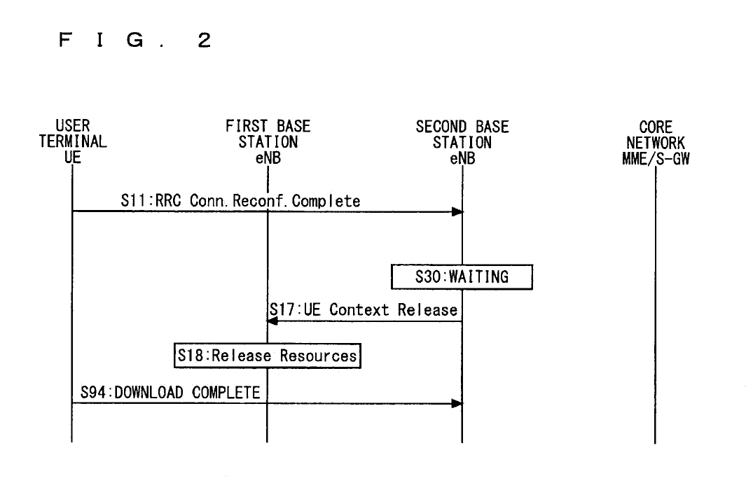

FIG. 2 is a view explaining a communication technology according to the second embodiment, which omits the illustration of the processes from Steps S91 to S09 and the processes of Steps S12 and S16 and Step S24 and its subsequent steps.

The second base station eNB waits for a predetermined period of time in Step S30 after being notified of the message (for example, RRC Connection Reconfiguration

Complete referred to in 3GPP TS36.300) of Step S11 from the user terminal UE. Step S30 may be started before or after Steps S12 and S16. For example, Step S30 may be started with Step S11 as a trigger. The process described in the first embodiment is the process when Step S94 is executed during the waiting in Step S30.

In the second embodiment, Steps S17 and S18 are executed after a lapse of the predetermined period of time. In Step S17, the second base station eNB notifies the first base station eNB that the first base station eNB is requested to release the user information, as in Step S37. Consequently, in Step S18, the first base station eNB releases the user information, as in Step S38.

Executing Steps S17 and S18 to release the user information registered with the first base station eNB only after the waiting in Step S30 without the execution of Step S94 is desirable in the following respect. Specifically, for a short period of time required for downloading the data desired by the user terminal UE, the first base station eNB does not release the user information and quickly executes or does not require Step S25 in the first embodiment; for a long period of time required for the downloading, the first base station eNB releases the user information, thereby preventing a reduction in the traffic capacity of the first base station eNB.

The above-mentioned waiting in Step S30 can be recognized as a timer function referred to as a UE context Release timer.

### Third Embodiment

In the descriptions of the first embodiment and the second embodiment, whether the communication areas (also referred to as “cells”) covered by the first base station eNB and the second base station eNB are large or small is not identified. However, setting the cell of the first base station eNB to be larger than the cell of the second base station eNB makes the advantages of the first and second embodiments more conspicuous.

For example, the first base station eNB corresponds to a macro cell, and the second base station eNB corresponds to a small cell.

The first base station eNB connects more user terminals UE to the core network MME/S-GW than the second base station eNB does. When the handover as described in the first and second embodiments is not performed, accordingly, traffic capacity is reduced if an increasing number of user terminals UE issue a download request of Step S91 to the core network MME/S-GW. Thus, the base station eNB involved in the connection between the user terminal UE that has requested a download and the core network MME/S-GW is changed (handover) from the first base station eNB to the second base station eNB.

Consequently, a reduction in the traffic capacity of the first base station eNB is prevented. This is particularly advantageous when the capacity of the data to be downloaded is high.

### Fourth Embodiment

In the descriptions of the first embodiment and the second embodiment, whether the transmission rates of the first base station eNB and the second base station eNB are high or low is not identified. Selecting the transmission rate of the second base station eNB to be higher than the transmission rate of the first base station eNB, however, makes the advantages of the first and second embodiments more conspicuous.

The second base station eNB can be connected to limited user terminals that need high-rate transmission by issuing a download request, without the use of special identification information. As a result, the process of the second base station eNB is dedicated to the process for the communication that needs a high rate transmission rate, while the first base station eNB is dedicated to the process for the communication that needs a low transmission rate. This allows the connection to the second base station eNB to be promptly handed over to a user that needs a high transmission rate.

Therefore, the interference between two types of communication using different transmission rates, which is conceivable when the two types of communication coexist in the same base station eNB, can be mitigated.

For such interference, when the communication of the user terminal UE with both of the first base station eNB and the second base station eNB is radio communication, it is also desirable to set a frequency used in the radio communication with the first base station eNB and a frequency used in the radio communication with the second base station eNB to different values. This is because the radio communication performed at high transmission rate with high power is less likely to interfere with the radio communication performed at low transmission rate with low power. Needless to say, these frequencies are not necessarily required to be set to different values but may be set to the same value in the first and second embodiments.

In one base station eNB, preferentially scheduling a user terminal UE, which has issued a download request, to communication of high transmission rate may lead to an unfair situation: the user terminal UE occupies the traffic of the base station eNB. In contrast, a handover performed as in the first and second embodiments can mitigate such unfair scheduling.

It is also desirable that the cell of the first base station eNB be larger than the cell of the second base station eNB and that the transmission rate of the second base station eNB be higher than the transmission rate of the cell of the first base station eNB. The reason for this is as follows: as suggested in Patent Document 1, the power required for communication of high transmission rate becomes higher, but a smaller cell can prevent an increase in the power. Additionally, the transmission rate in communication of the first base station eNB is low, and the power required for the communication is low, thereby enabling communication with a large number of user terminals UE in a large cell. Such a reduction in power consumption also contributes to the miniaturization of the first base station eNB and the second base station eNB.

Communication connection with the small cell is preferentially allocated to the user in need of high-rate transmission, so that the user can efficiently obtain high-capacity communication service. The communication of the macro cell is mainly transmitted at low rate, allowing more users to be accommodated. Additionally, the interference associated with high-rate transmission by another user or the influence of scheduling allocation is reduced, enabling stable communication.

### Fifth Embodiment

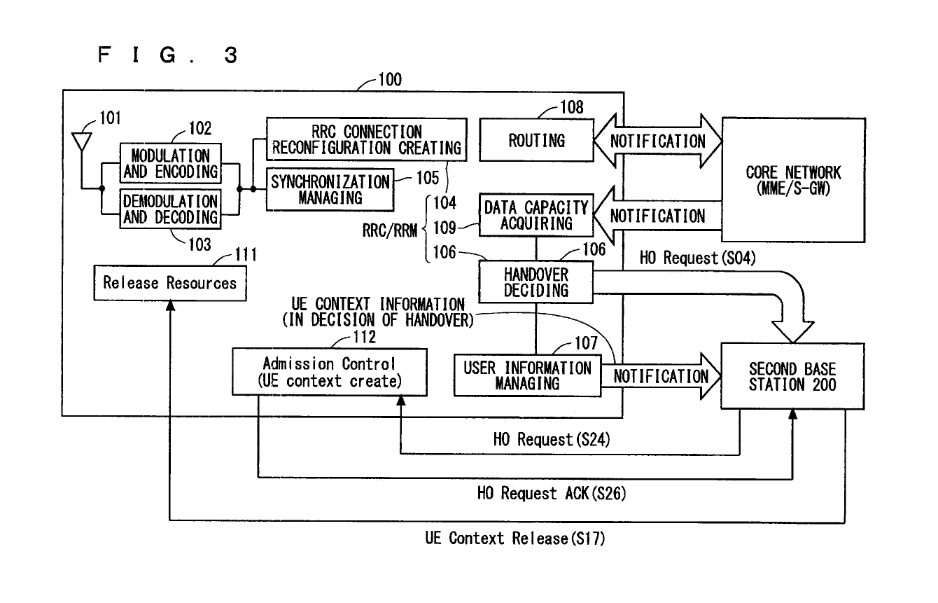

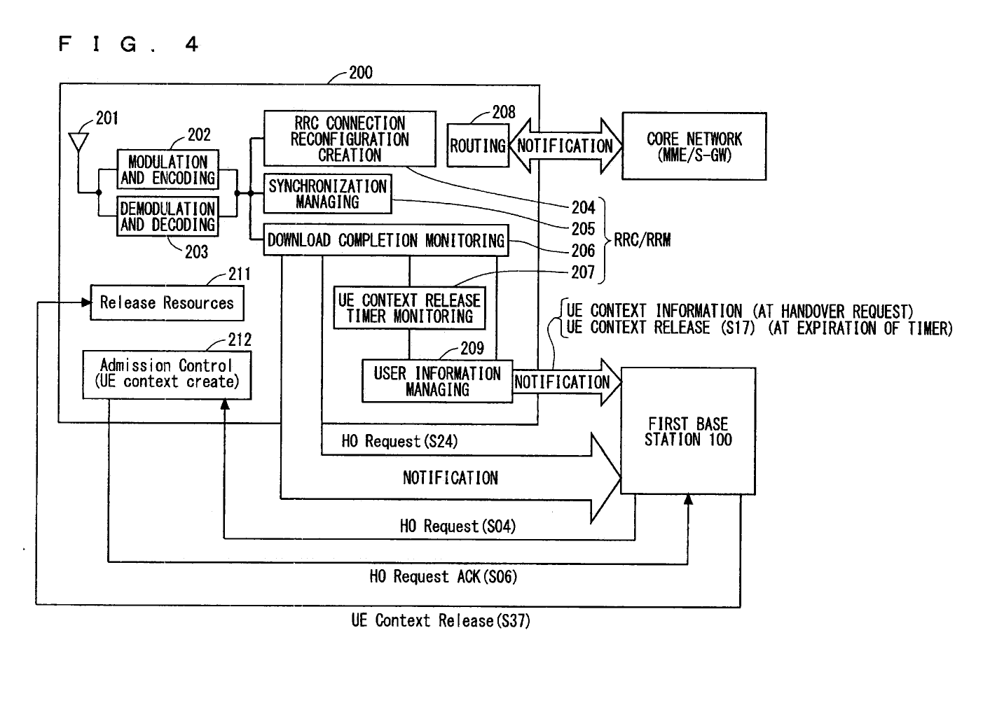

FIGS. 3 and 4 are block diagrams explaining configuration examples of the first base station eNB and the second base station eNB, respectively. The sequences described in the first and second embodiments can be achieved with these configuration examples. The following illustrates the case in which a user terminal UE is capable of radio communication with both of the first base station eNB and the second base station eNB.

With reference to FIG. 3, a first base station 100 includes an antenna unit 101, a modulation and encoding unit 102, a demodulation and decoding unit 103, a message creation unit 104, a synchronization managing unit 105, a handover deciding unit 106, a user information managing unit 107, a routing unit 108, a data capacity acquiring unit 109, a user information release unit 111, and an admission control unit 112.

A reception signal received through the antenna unit 101 is demodulated and decoded by the demodulation and decoding unit 103. Whether or not the reception signal demodulated and decoded is in a synchronized state is decided by the synchronization managing unit 105 through comparison between an SINR (Signal to Interference plus Noise Ratio) calculated from a known signal such as a reference signal of signal components and its threshold. The value to be calculated may be an SIR (Signal to Interference Ratio) or an SNR (Signal to Noise Ratio), as well as SINR.

The message creation unit 104 creates a message (for example, RRC Connection Reconfiguration referred to in 3GPP TS36.300) to be transmitted to the user terminal UE in Step S07 (see FIG. 1). The message is modulated and encoded by the modulation and encoding unit 102, so that a transmission signal is created.

The antenna unit 101 transmits the message by radio to the user terminal UE. Additionally, received is the message (for example, RRC Connection Reconfiguration Complete referred to in 3GPP TS36.300) of Step S31 (see FIG. 1) received from the user terminal UE. The received message is demodulated and decoded by the demodulation and decoding unit 103, and then, is subjected to the decision as to whether the reconfiguration of communication has been completed normally. This decision is made by a radio control unit RRC/RRM (Radio Resource Control/Radio Resource Management). The radio control unit RRC/RRM includes at least the message creation unit 104. FIG. 3 illustrates the case in which the radio control unit RRC/RRM includes the handover deciding unit 106 and the data capacity acquiring unit 109 in addition to the message creation unit 104. The radio control unit RRC/RRM, however, may be configured without including the handover deciding unit 106 and the data capacity acquiring unit 109. Alternatively, the radio control unit RRC/RRM may include the synchronization managing unit 105.

The information on the capacity (data capacity) of the to-be-downloaded data requested by the user terminal UE in Step S91 (see FIG. 1), which has been notified in Step S93 (see FIG. 1) from the core network MME/S-GW, is obtained by the data capacity acquiring unit 109.

The handover deciding unit 106 decides in Step S03 (see FIG. 1) whether to perform a handover to the second base station eNB on the basis of the size of data capacity. When deciding to perform a handover, the handover deciding unit 106 notifies the second base station eNB of the handover request of Step S04. The user information managing unit 107 notifies a second base station 200 of UE context information for use in the creation of user information (UE context create) on the second base station eNB side.

Triggered by receipt of the notification (for example, Release Resources referred to in 3GPP TS36.300) of Step S17 (see FIG. 2), the user information release unit 111 releases the user information (see Step S18 of FIG. 2).

The routing unit 108 transmits and receives the notification on the routing configuration to and from the core network MME/S-GW side.

With reference to FIG. 4, the second base station 200 includes an antenna unit 201, a modulation and encoding unit 202, a demodulation and decoding unit 203, a message creation unit 204, a synchronization managing unit 205, a download completion monitoring unit 206, a timer monitoring unit 207, a routing unit 208, a user information managing unit 209, a user information release unit 211, and an admission control unit 212.

A reception signal received through the antenna unit 201 is demodulated and decoded by the demodulation and decoding unit 203. Whether or not the reception signal demodulated and decoded is in a synchronized state is decided by the synchronization managing unit 205, similarly to the synchronization managing unit 105.

The message creation unit 204 creates a message (for example, RRC Connection Reconfiguration referred to in 3GPP TS36.300) to be transmitted to the user terminal UE in Step S27 (see FIG. 1). The message is modulated and encoded by the modulation and encoding unit 202, so that a transmission signal is created.

The antenna unit 201 transmits the message by radio to the user terminal UE. Additionally, received is the message (for example, RRC Connection Reconfiguration Complete referred to in 3GPP TS36.300) of Step S11 (see FIG. 1) received from the user terminal UE. The received message is demodulated and decoded by the demodulation and decoding unit 203, and then, is subjected to the decision as to whether or not the reconfiguration of communication has been completed normally. This decision is made by the radio control unit RRC/RRM. The radio control unit RRC/RRM includes at least the message creation unit 204. FIG. 4 illustrates the case in which the radio control unit RRC/RRM includes the synchronization managing unit 205, the download completion monitoring unit 206, and the timer monitoring unit 207 in addition to the message creation unit 204. The radio control unit RRC/RRM, however, may be configured without including the synchronization managing unit 205, the download completion monitoring unit 206, and the timer monitoring unit 207.

The download completion monitoring unit 206 identifies the presence or absence of the notification (whether download has been completed) of Step S94 based on the contents of the decoded reception signal. Trigged by a decision that the notification of S94 has been received from the user terminal UE (deciding that a download has been completed), the download completion monitoring unit 206 requests a handover from the first base station 100 (notifies the first base station 100 of a handover request, see Step S24 of FIG. 1) without deciding whether to execute a handover.

The timer monitoring unit 207 monitors, using a timer (UE context Release timer described above), whether a certain period of time has elapsed since the reception of the affirmative response of Step S16 from the core network MME/S-GW. When a certain period of time has elapsed without receiving the decision that a download has been completed from the download completion monitoring unit 206 (see Step S30 of FIG. 2), the timer monitoring unit 207 decides that the timer has expired and then notifies the user information managing unit 209 that the timer has expired. Upon notification of the expiration of the timer, the user information managing unit 209 requests the first base station 100 side to release the user information (notifies UE context release), as described in Step S17 (see FIG. 2).

When receiving the decision that a download has been completed from the download completion monitoring unit 206 before a lapse of a certain period of time, the timer monitoring unit 207 stops the timer. This causes the download completion monitoring unit 206 to notify the first base station 100 of a handover request (Step S24) while a release of the user information is not requested.

The routing unit 208 transmits and receives the notification on the routing configuration to and from the core network MME/S-GW side. Specifically, the routing units 208 and 108 notify the requests in Steps S12 and S32 above, and the affirmative responses of Steps S16 and S36 are notified to the routing units 208 and 108.

Triggered by receipt of the notification (for example, Release Resources referred to in 3GPP TS36.300) of Step S37 (see FIG. 1), the user information release unit 211 releases the user information (see Step S38 of FIG. 1).

Triggered by receipt of the handover request from the first base station 100 (Step S04), the admission control unit 212 creates the user information (UE context create) using the UE context information notified from the user information managing unit 107. When the above-mentioned creation is performed normally, the affirmative response (Step S06) to the handover request is notified to the first base station 100. In the first base station 100, the affirmative response is transmitted to the message creation unit 104 via the antenna unit 101 and the demodulation and decoding unit 103, so that the message to be transmitted to the user terminal UE (Step S07) is created.

Similarly, with reference to FIG. 3, the admission control unit 112 receives the handover request (Step S24) from the second base station 200, thereby creating the user information (UE context create) using the UE context information notified from the user information managing unit 209. When this creation is performed normally, the affirmative response (Step S26) to the handover request is notified to the second base station 200. In the second base station 200, the affirmative response is transmitted to the message creation unit 204 via the antenna unit 201 and the demodulation and decoding unit 203, so that the message (Step S27) to be transmitted to the user terminal UE is created.

When the second base station 200 requests a handover from the first base station 100 after the timer has expired and Steps S17 and S18 have been executed once, similarly to the user information managing unit 107, the user information managing unit 209 notifies the first base station 100 of the UE context information for use in the creation of the user information (UE context create) on the first base station 100 side. This notification, however, is not made when the completion of the download in Step S94 is notified before the expiration of the timer (because the first base station 100 has not released the user information).

The technology according to this embodiment contributes to the realization of the technologies described in the first to fourth embodiments.

The embodiments of the present invention can be freely combined or appropriately modified or omitted within the scope of the invention.

While the invention has been shown and described in detail, the foregoing description is in all aspects illustrative and not restrictive. It is therefore understood that numerous modifications and variations can be devised without departing from the scope of the invention.

### DESCRIPTION OF REFERENCE NUMERALS

100: first base station (eNB), 106: handover deciding unit, 109: data capacity acquiring unit, 200: second base station (eNB), 206: download completion monitoring unit, 208: routing unit, 209: user information managing unit, UE: user terminal, MME/S-GW: core network.

1. A communication method in a communication system comprising a network, a first base station, a second base station, and a terminal connectable to said network via any of said first base station and said second base station,
said communication method comprising the steps of:
(a) issuing, by said terminal being connected to said network via said first base station and not being connected to said second base station, a reception request for requesting a download of data to said first base station;
(b) determining, by said first base station, whether or not to connect said terminal to said second base station correspondingly to said reception request;
(c) causing, by said first base station, said second base station to admit that said terminal is to be connected to said second base station when the determination of said step (b) is affirmative;
(d) after said step (c), transmitting, by said terminal, a notification indicating that communication between said terminal and said second base station is enabled to said second base station; and
(e) after said step (d), after said terminal has completed said download, enabling, by said first base station, communication from said network via said first base station without determining whether or not to connect said terminal to said first base station.

2. The communication method according to claim 1, further comprising
the step of (f) after said step (d), when said download has been completed within a predetermined period, enabling the communication from said network via said first base station without releasing information on said terminal from said first base station.

3. The communication method according to claim 1, further comprising
the step of (g) after said step (d), releasing information on said terminal from said first base station when said download has not been completed within a predetermined period.

4. The communication method according to claim 1, wherein a communication area of said first base station is larger than a communication area of said second base station.

5. The communication method according to claim 1, wherein a transmission rate of said second base station is higher than a transmission rate of said first base station.

6. The communication method according to claim 5, wherein
communication of said terminal with both of said first base station and said second base station is radio communication, and
a value of a frequency used in the radio communication performed between said terminal and said first base station differs from a value of a frequency used in the radio communication performed between said terminal and said second base station.

7. The communication method according to claim 1, wherein in said step (b), a capacity of said data requested in said step (a) is notified from said network to said first base station, and connecting said terminal to said second base station is decided when the capacity of said data is greater than a predetermined value.

8. A communication apparatus being a base station involved in communication between a network and a terminal, said terminal being communicable with said network also via another base station,
said communication apparatus comprising:
a routing unit that requests, from said network, establishment of a communication path from said network to said communication apparatus; and
a download completion monitoring unit that monitors whether or not said terminal has completed a download of data from said network via said base station and, when or not deciding that said download has been completed before a lapse of a predetermined period of time from said establishment, requests a handover to said another base station without requesting said another base station to release user information of said terminal.

9. A communication apparatus being a base station involved in communication between a network and a terminal, said terminal being communicable with said network also via another base station,
said communication apparatus comprising:
a routing unit that requests, from said network, establishment of a communication path from said network to said communication apparatus; and
a download completion monitoring unit that monitors whether or not said terminal has completed a download of data from said network via said base station and, triggered by a decision that said download has been completed, requests a handover to said another base station.

10. A communication apparatus being a base station involved in communication between a network and a terminal, said terminal being communicable with said network also with another base station,
said communication apparatus comprising:
a routing unit that requests, from said network, a process of causing a communication path from said network to said terminal to transit said another base station;
a download completion monitoring unit that monitors whether or not said terminal has completed a download of data from said network via said base station; and
a user information managing unit that requests, when deciding that a predetermined period of time has elapsed since said process before said download is completed, said another base station to release user information of said terminal.

11. A communication apparatus being a base station involved in communication between a network and a terminal, said communication apparatus comprising:
a data capacity acquiring unit that obtains, triggered by receipt of a reception request from the terminal for requesting reception of data from said network, information on a capacity of said data from said network; and
a handover deciding unit that decides whether or not to cause said terminal to be connected to another base station on the basis of the capacity of said data.
